(19) United States
(12) Patent Application Publication
(10) Pub. No.: US 2008/0007482 A1
(43) Pub. Date: Jan. 10, 2008

(54) Display apparatus and electronic apparatus having the display apparatus

(75) Inventor: Hirohito Morioka, Kitakatsuragi-gun (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/822,436

(22) Filed: Jul. 5, 2007

(30) Foreign Application Priority Data
Jul. 6, 2006 (JP) 2006-186791

(51) Int. Cl. G09G 5/00

(52) U.S. Cl. 345/1.1

(57) ABSTRACT

A display apparatus comprising a display portion capable of simultaneously displaying a first image and a second image, the first image being viewable from a position in a first view angle and the second image being viewable from a position in a second view angle, wherein the display apparatus has a reflective member reflecting the second image and displays predetermined specific information through the second image, the reflective member offering a third view angle that allows viewing of the second image.

### CROSS-NOTING PARAGRAPH

This Non-provisional application claims priority under 35 U.S.C. §119 (a) on Patent Application No. 2006-186791 filed in JAPAN on Jul. 6, 2006, the entire contents of which are hereby incorporated herein by reference.

### FIELD OF THE INVENTION

The present invention relates generally to a display apparatus and an electronic apparatus having the display apparatus, and, more particularly, to a display apparatus having a display portion capable of dual view display.

### BACKGROUND OF THE INVENTION

A liquid crystal display adopting a dual view method has been known in the technical field of image display. Such a liquid crystal display has been disclosed in Japanese Laid-Open Patent Publication Nos. 2005-284592 and 2005-078076.

FIGS. 1A to 1C are explanatory views of the above liquid crystal display adopting the dual view method. FIG. 1A is a front schematic view of the liquid crystal display adopting the dual view method (hereinafter “dual view liquid crystal panel”), FIG. 1B is a top schematic view of the dual view liquid crystal panel, and FIG. 1C is an explanatory view of view angles of the dual view liquid crystal panel.

The dual view liquid crystal panel 210 is illuminated with a backlight 220 from the back face of the liquid crystal panel 210, and displays an image according to an input image signal.

As shown in FIGS. 1A to 1C, the dual view method is carried out in such a way that the display screen of the dual view liquid crystal panel 210 displays a first image in a first direction (D1), and also displays a second image in a second direction (D2) different from the first direction (D1). The first image and the second image are displayed as images different from each other.

According to the dual view liquid crystal panel 210, the view angle a of the first image displayed in the first direction D1 is different from the view angle b of the second image displayed in the second direction, as shown in FIG. 1C. A user, therefore, cannot view the second image at a visual position 230 where the first image is viewable, and cannot view the first image at a visual position 240 where the second image is viewable. In this manner, the dual view liquid crystal panel 210 can provide each separate display image for users within the view angles a and b, respectively.

For example, the dual view liquid crystal panel is disposed at the center of a console of a car, and is operated to display the view of the car navigation and the state of a car in the driver's seat side of the screen and also display a movie, TV program, etc., in the passenger's seat side of the screen. This enables the dual view liquid crystal panel to provide users whose viewing directions different from each other with respective proper information.

As described above, the dual view liquid crystal panel described in the above Japanese Laid-Open Patent Publication Nos. 2005-284592 and 2005-078076 allow users at different visual positions to view different images, respectively. In practical application of the dual view liquid crystal panel, however, no one has come up with such an application of the dual view liquid crystal panel that a viewable range is limited for a specific image in consideration of the view angle of each image.

An MFP (Multifunction Peripheral) for example is known as an electronic apparatus having a liquid crystal panel display, offering combined functions of printing, scanning, copying, faxing, e-mailing, etc.

Such an MFP sometimes displays data allowing the identification of a specific individual, company, organization, etc., such as name, fax number, or e-mail address, in executing the combined functions.

For example, the MFP may print out image data transmitted from an external device, using a printer function, or may display log data for a printer process. The log data usually contains such preset data as an account of IDs and passwords and user names.

In another case, when the MFP transmits image data, etc., to an external fax machine using a fax function or to an external device using an e-mail function, the MFP displays an address book on the screen, on which a user performs operation of specifying a contact party. The address book naturally contains personal information and information allowing the identification of a company, etc.

Such information allowing the identification of an individual, company, etc., is usually handled as the information related to security, that is, the information requiring ensured security, and thus is put under control so that unwanted information leak does not happen. Hereinafter, such information is called security information.

Besides, information related to the basic setting of the MFP may also be handled as security information. For example, the information that can be set in the basic setting of the MFP by only the person who has a specific authority, such as an administrator, is the information that must not be leaked easily to another person. For example, an IP address is set in network setting, so the network setting information is regarded as security information.

When security information, such as personal information, is displayed on the display screen, however, another person near the MFP may peep into the display screen, which raises a risk of security information leaking. Since an ordinary display screen has a view angle of a size that allows peeping from the side, a risk of information leaking is involved whenever security information is displayed.

### SUMMARY OF THE INVENTION

An object of the present invention is to provide a display apparatus capable of carrying out display that maintains security through a narrow limited range of a view angle of a display screen displaying security information by causing a reflective member to display the security information using a dual view liquid crystal display having view angles in different directions, and to provide an electronic apparatus having the display apparatus.

Another object of the present invention is to provide a display apparatus including a display portion capable of simultaneously displaying a first image and a second image, the first image being viewable from a position in a first view angle and the second image being viewable from a position in a second view angle, wherein the display apparatus has a reflective member for reflecting the second image and displays predetermined specific information through the second image, and the reflective member provides a third view angle allowing viewing of the second image.

Yet another object of the present invention is to provide a display apparatus so configured that a third view angle is a view angle narrower in range than a first view angle, and that both of a first image displayed by the display apparatus and a second image reflected by a reflective member are viewable from a position in the third view angle.

Still another object of the present invention is to provide a display apparatus wherein the specific information is the information on security.

Yet still another object of the present invention is to provide a display apparatus wherein the specific information is the information of the basic setting of the display apparatus or of an apparatus incorporating the display apparatus.

A further object of the present invention is to provide a display apparatus wherein the specific information is the information on personal information.

A yet further object of the present invention is to provide a display apparatus wherein the specific information is information on a transmission destination of the information to be transmitted.

A still further object of the present invention is to provide a display apparatus wherein a reflective member is adjustable in angle relative to a display portion.

A yet still further object of the present invention is to provide a display apparatus wherein a display portion so carries out display as to make a display area for a second image smaller than a display area for a first image.

A still yet further object of the present invention is to provide an electronic apparatus that has the above display apparatus and allows given operational input to the display apparatus.

### BRIEF DESCRIPTION OF THE DRAWINGS

FIGS. 1A to 1C are explanatory views of a liquid crystal display adopting a dual view method;

FIG. 2 is an explanatory view of one embodiment of a display apparatus according to the present invention;

FIG. 3 is a diagrammatic view of a mechanism of image display carried out by the display apparatus shown in FIG. 2;

FIG. 4 is an explanatory view of a principle of display by a dual view liquid crystal panel applicable to the present invention;

FIG. 5 is an explanatory view of a field of view provided by the dual view liquid crystal panel and a reflective member;

FIG. 6 depicts one embodiment of an electronic apparatus having the display apparatus according to the present invention;

FIG. 7 depicts an example which the mounting position of the reflecting portion on the MFP shown in FIG. 6 is changed;

FIGS. 8A and 8B depict examples of displays of a first image and a second image;

FIGS. 9A and 9B depict examples of displays that result when the user views the display images shown in FIGS. 8A and 8B;

FIGS. 10A and 10B depict another examples of displays of the first image and the second image;

FIGS. 11A and 11B depict still another examples of displays of the first image and the second image;

FIGS. 12A and 12B depict still another examples of displays of the first image and the second image; and

FIG. 13 is a block diagram for explaining the internal configuration of the display apparatus according to the present invention.

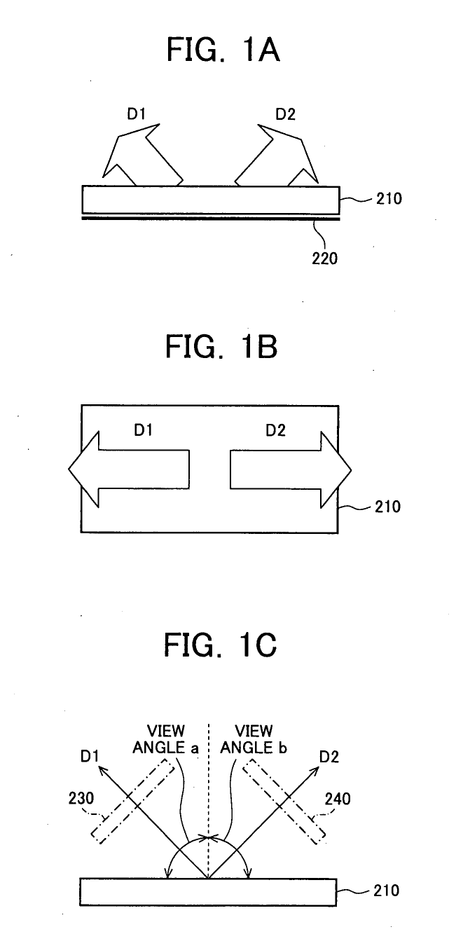

### PREFERRED EMBODIMENTS OF THE INVENTION

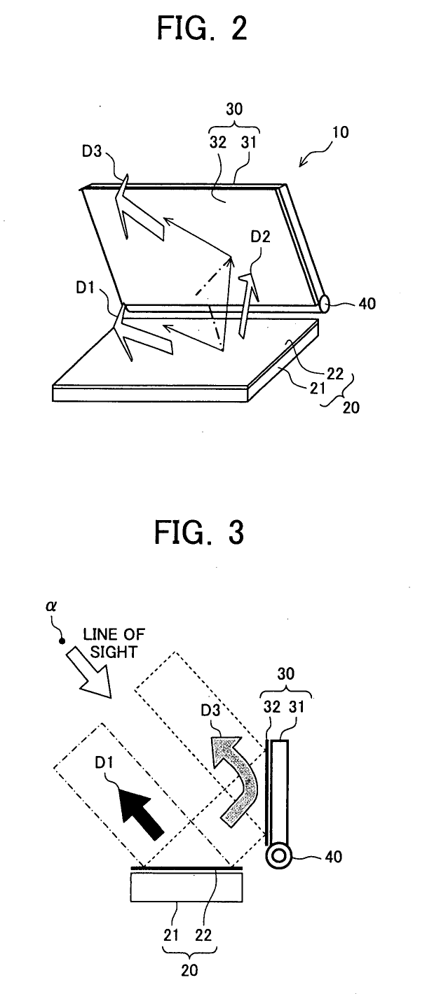

FIG. 2 is an explanatory view of one embodiment of a display apparatus according to the present invention. In FIG. 2, 10 denotes the display apparatus, 20 denotes a display portion, 21 denotes a dual view liquid crystal panel, 22 denotes a first touch panel, 30 denotes a reflecting portion, 31 denotes a reflective member, 32 denotes a second touch panel, and 40 denotes a hinge.

The display apparatus 10 has the display portion 20 and the reflecting portion 30. The display portion 20 includes the dual view liquid crystal panel 21 and the first touch panel 22, and the reflecting portion 30 includes the reflective member 31 and the second touch panel 32.

As mentioned above, the dual view liquid crystal panel 21 is capable of simultaneously displaying a first image, which is viewable from a position in a first view angle, and a second image, which is viewable from a position in a second view angle.

In FIG. 2, the first view angle is set ahead D1 of the display portion 20, and the second view angle is set at the rear D2 of the display portion 20. This means that a user situated in the first view angle of the display portion 20 can view the first image displayed on the dual view liquid crystal panel 21.

The reflecting portion 30 is provided with the hinge 40, and is configured to be rotatable on the hinge 40 as a rotating shaft. The hinge 40 allows variable setting of the angle of the reflecting portion 30 to the display portion 20. The reflective member 31 has a reflecting surface such as a mirror.

The hinge 40 may be so disposed as to connect the display portion 20 to the reflecting portion 30 via the hinge 40, or may be disposed in a place separated away from the display portion 20. The reflecting portion 30 is effective when it can reflect the second image of the display portion 20 to provide a view angle in a desired direction D3 (third view angle). The direction of the third view angle changes according to the angle of the reflecting portion 30.

According to the present invention, the hinge 40 having a hinge mechanism is not the only option, but a component configured to allow variable setting of the angle of the reflecting portion 30 can be employed properly to replace the hinge 40. Another configuration may also be possible such that the reflecting portion 30 is fixed at a given angle without having the hinge 40 if the line of sight of a user is in a limited range.

The first and second touch panels 22 and 32 are disposed respectively on the screen of the dual view liquid crystal panel 21 and on the reflecting surface of the reflective member 31. The touch panels 22 and 32 allow input operation.

FIG. 3 is a diagrammatic view of a mechanism of image display carried out by the display apparatus shown in FIG. 2. The reflective member 31 reflects the second image displayed on the dual view liquid crystal panel 21. For example, when the display portion 20 and the reflecting portion 30 are virtually perpendicular to each other, as shown in FIG. 3, the first image having a view angle in the direction D1 and the second image reflected from the reflective member 31 and having a view angle in the direction D3 can be viewed from a visual position α. At this time, the second image reflected from the reflective member 31 becomes the reversed image (mirror image) of the original image displayed on the dual view liquid crystal panel 21.

The original second image displayed on the dual view liquid crystal panel 21 is, therefore, generated and displayed in advance as a mirror image that is the reversed image of an image viewed by the user. As a result, the original second image is reversed at the reflective member 31 to become a desired image to be viewable by the user.

The user viewing the display portion 20 and reflecting portion 30 operates the first touch panel 22 on the display portion 20 and the second touch panel 32 on the reflecting portion 30 to perform desired input. In this case, the user is allowed to operate the first touch panel 22 according to the first image displayed on the display portion 20, and to operate the second touch panel 32 according to the second image reflected on the reflecting portion 30.

The touch panels 22 and 32 are not the constituent elements that are essential to the display portion 20 and the reflecting portion 30, and a configuration without including the touch panels 22 and 32 is also applicable. In such a case, input operation is made possible by providing a group of hard keys, such as ten-key, other pointing devices, etc.

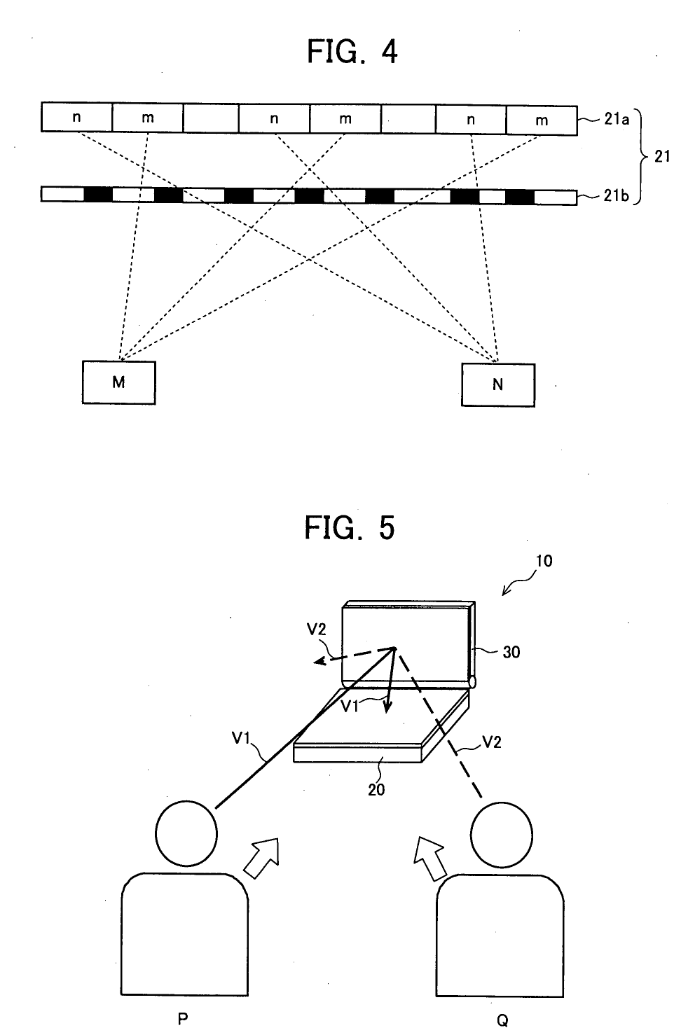

FIG. 4 is an explanatory view of a principle of display by the dual view liquid crystal panel applicable to the present invention.

The dual view liquid crystal panel 21 includes a liquid crystal panel 21a having a plurality of pixels m and n, and a parallax barrier (optical system separating element) 21b that is arranged to cover the entire surface of the liquid crystal panel 21a. The parallax barrier is a screen that has a plurality of vertical translucent slits spaced apart by nontransparent areas.

Light passing through the pixels m of the liquid crystal panel 21a travels further through the translucent slits of the parallax barrier 21b to reach a viewer M situated in a place that makes a given view angle with the display face of the liquid crystal panel 21a.

Light passing through the pixels n of the liquid crystal panel 21a travels further through the translucent slits of the parallax barrier 21b to reach a viewer N situated in a place that makes a given view angle to the display face of the liquid crystal panel 21a.

An image displayed on the liquid crystal panel 21a can be seen from no areas but a definite area in space because of the presence of the plurality of translucent slits of the parallax barrier 21b. As a result, each viewer M and N can see each different image.

To carry out dual view display, for example, adjacent pixels of the liquid crystal panel 21a are driven according to image data for the viewers M or N. In other words, adjacent pixels of the liquid crystal panel 21a are driven according to different image data for different directions. The pixels may be driven at intervals of every other pixel according to image data different from each other, or may be driven at intervals of every one or more pixels, such as every two or every three pixels. The driving intervals are set according to the width of the translucent slits of the parallax barrier 21b.

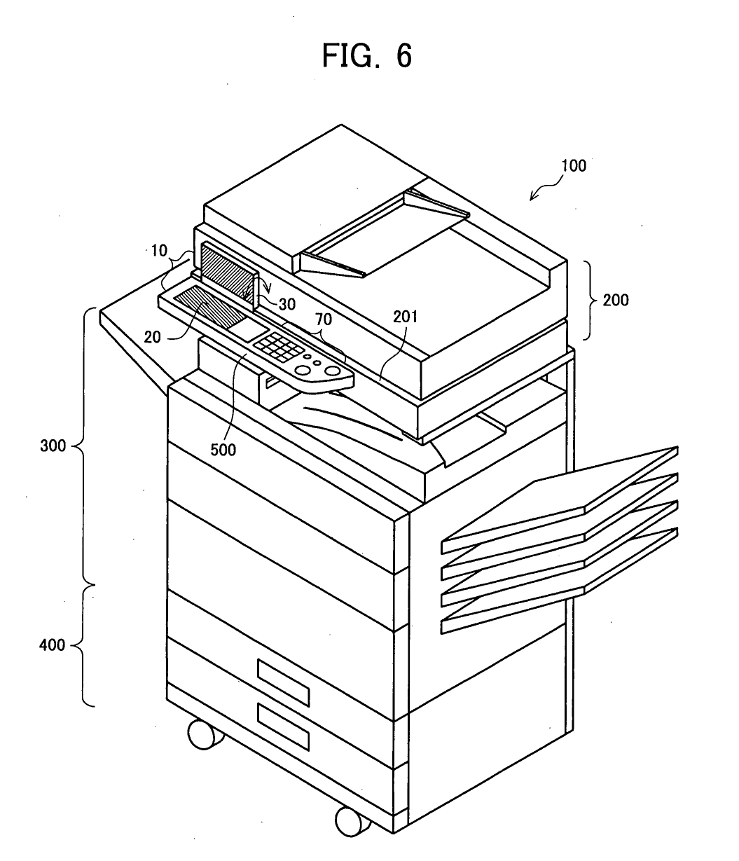

FIG. 5 is an explanatory view of a field of view provided by the dual view liquid crystal panel and the reflective member.

A user is usually allowed to view the second image reflected on the reflecting portion 30. When the second image displayed on the display portion 20 is viewed using the reflecting portion 30, however, a viewable area for the second image (third view angle given by the reflecting portion 30) is limited to a narrow range.

As shown in FIG. 5, for example, a user P standing in front of the display apparatus 10 can view the first image displayed on the display portion 20 and the second image reflected on the reflecting portion 30. In this case, the angle (incidence angle) of the user P's line of sight V1 to the reflecting portion 30 is close to zero, so that the user P can view the second image displayed on the display portion 20 through the line of sight V1.

In contrast, when another person Q standing near the user P views the reflecting portion 30 through another person Q's line of sight V2, the angle (incidence angle) of the line of sight V2 to the reflecting portion 30 is large. As a result, another person Q cannot view the second image displayed on the display portion 20. In other words, the configuration using the reflecting portion 30 reduces the view angle of the second image given by the reflecting portion 30 into a very narrow range. Obviously to say, the view angle of the second image given by the reflecting portion 30 is smaller than the view angle of the first image given by the display portion 20.

In this manner, peeping into the second image reflected on the reflecting portion 30 from the side of the user who is viewing the display portion 20 from its front is difficult. According to the embodiment of the present invention, security information is displayed on the second image reflected on the reflecting portion 30 in the use of the configuration including the display portion 20 using the dual view liquid crystal panel 21 and the reflecting portion 30. This effectively prevents a leak of security information to others.

Security information is, as described above, specific information of which security must be secured. For example, security information includes information of the basic setting of the display apparatus, such as information of network setting that can be determined by an administrator, etc., having a specific authority, personal information, and information which is contained in address book information, etc., and identifies a contact party in transmission.

Personal information includes, for example, an individual name, date of birth, age, sex, address, phone number, family structure, hobby, taste, e-mail address, place of work, post, office address, office phone number, credit card number, bank account number, and various numbers and character strings appended to an individual. Personal information also includes information that can be checked easily with other information to enable the identification of a specific individual.

In this case, the display portion 20 may carry out display in such a way that a display area for the second image is smaller than a display area for the first image. The smaller display area for the second image makes it further difficult for another person Q to view the second image.

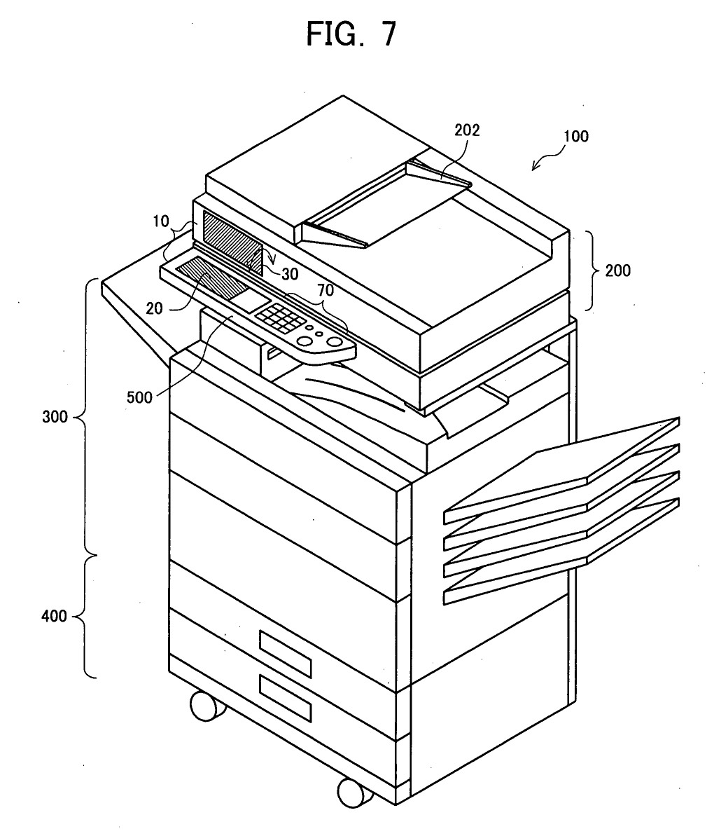

FIG. 6 depicts one embodiment of an electronic apparatus having the display apparatus according to the present invention. FIG. 6 exhibits an instance of application of an MFP which has functions of printing, scanning, copying, faxing, etc., as the electronic apparatus according to the present invention.

The MFP 100 includes an image reader (scanner) 200 that reads an image out of an original, using a CCD, etc., and outputs an image signal, an electrophotographic printer 300 that prints an image on a paper on the basis of an image signal transmitted from the image reader 200 or from an external device, and a paper feeding desk 400 that feeds papers sequentially into the printer 300.

An operating panel 500 is disposed on the side of an original glass plate 201 of the image reader 200. The operating panel 500 is fitted with the above display apparatus 10. The operating panel 500 has a group of hard keys 70 including a start key, ten-key, clear key, all clear key, and operation mode key. A user can perform given input operations using the group of hard keys 70 and the touch panels equipped on the display apparatus 10.

The display apparatus 10 has the configuration as shown in FIGS. 2 and 3, and includes the display portion 20 and the reflecting portion 30. According to the example shown in FIG. 6, the display portion 20 is disposed on the operating panel 500, and the reflecting portion 30 is disposed on a body frame composing the original glass plate 201. The reflecting portion 30 is attached to the body frame using a hinge, where the angle of the reflecting portion 30 can be set variably.

The reflecting portion 30 reflects the second image displayed on the dual view liquid crystal panel 21, enabling a user situated in the third view angle to view the second image. In this case, the first view angle and the third view angle should preferably be directed in the same direction so that the user of the MFP 100 can view both first and second images.

FIG. 7 depicts an example of the mounting position of the reflecting portion on the MFP shown in FIG. 6 is changed. In this example, the display portion 20 of the display apparatus 10 is disposed on the operating panel 500 as in the example shown in FIG. 6, but the reflecting portion 30 is disposed on the openable/closable frame of the image reader 200 having an original set tray 202.

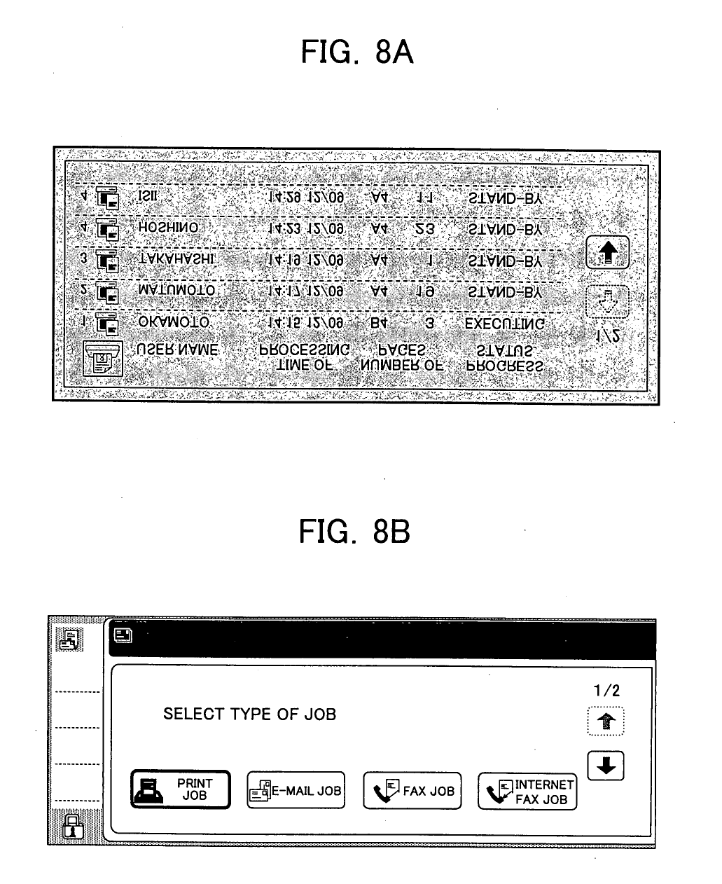

FIGS. 8A and 8B depict examples of displays of the first image and the second image. FIG. 8A depicts an example of display of the second image on the display portion, and FIG. 8B depicts an example of display of the first image on the display portion.

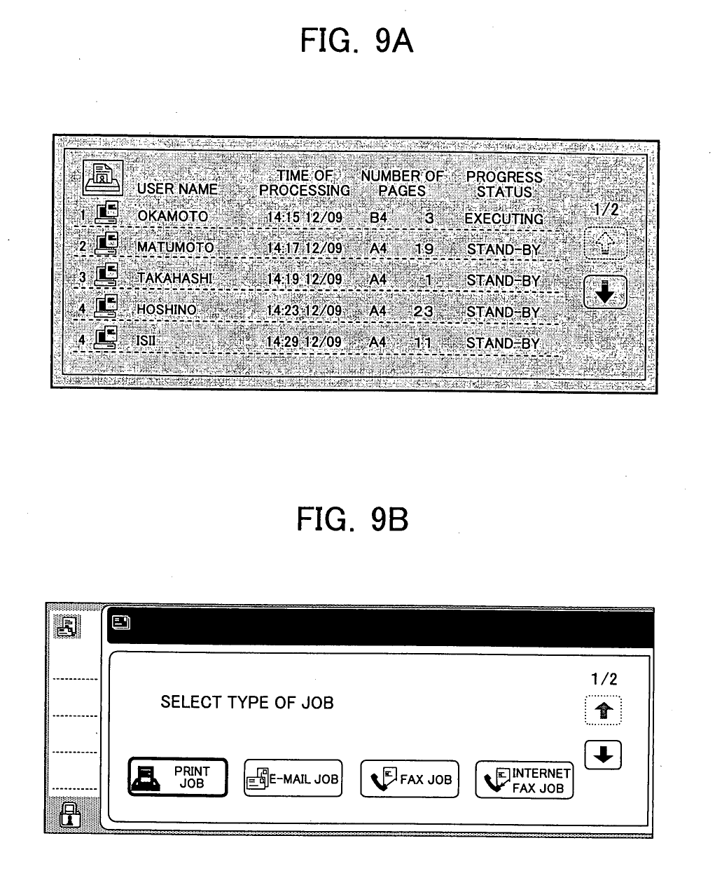

FIGS. 9A and 9B depict examples of displays that result when the user views the display images shown in FIGS. 8A and 8B. FIG. 9A depicts the second image that can be viewed via the reflecting portion 30, and FIG. 9B depicts the first image that can be viewed by looking directly into the display portion 20.

The dual view liquid crystal panel of the display portion 20 is capable of simultaneously displaying the first image as shown in FIG. 8B and the second image as shown in FIG. 8A.

FIGS. 8A and 8B depict examples of displays of a job list in a copy mode of the MFP. The job list is a picture that is displayed on the screen, for example, by pressing a job status display key set on an input stand-by image of the copy mode.

In the example shown in FIGS. 8A and 8B, the second image exhibits the above specific information requiring high level of security (security information). Here, the first image shown in FIG. 8B exhibits a screen for selecting a type of a job (print job, e-mail job, fax job, and internet fax job), and the second image exhibits the job list that appears as a result of selection of the print job on the first image. The job list contains such security information as user name, and is, therefore, displayed on the second image.

The second image shown in FIG. 8A is displayed as a mirror image that is given by reversing beforehand a desired image to be viewed by a user. As a result, as shown in FIGS. 9A and 9B, the second image viewed via the reflecting portion 30 becomes the reversed image of the mirror image displayed on the display portion 20.

According to the above configuration, the secrecy of security information can be maintained by displaying the security information on the second image. In addition to that, the configuration enables a wide display area of the job list.

In a conventional case, the job selection screen shown in FIG. 8B and the job list display screen shown in FIG. 8A are displayed on the same ordinary screen. In contrast, according to the present embodiment, the job list is displayed on the second image. This allows the relative enlargement of the display area of the job list that is separately exhibited as the second image, which enables an increase in information provided by the job list that can be viewed at a time.

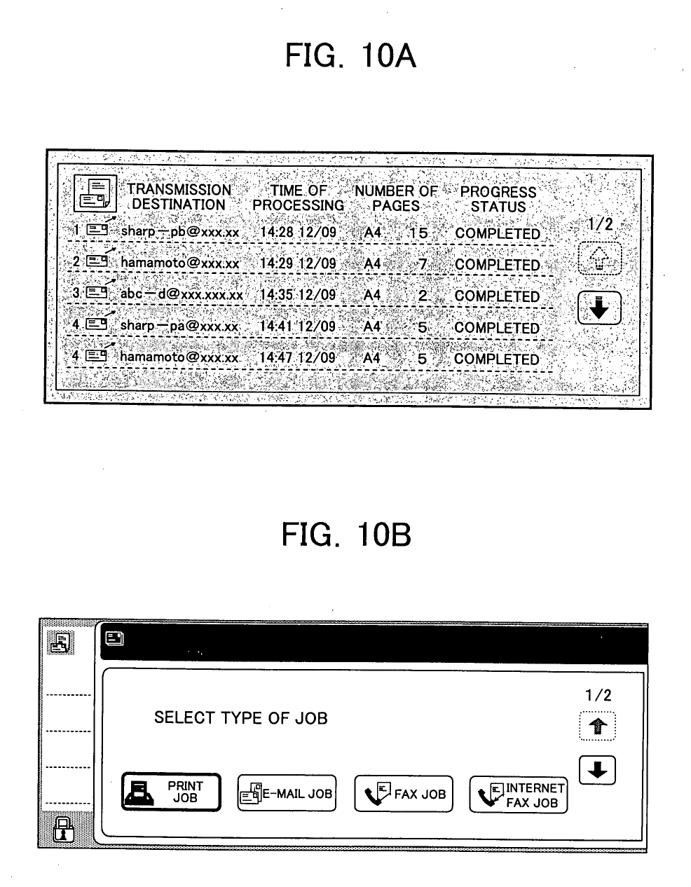

FIGS. 10A and 10B depict other examples of displays of the first image and the second image. FIG. 10A depicts the second image that can be viewed via the reflecting portion 30, and FIG. 10B depicts the first image that can be viewed by directly looking into the display portion 20.

The first image (FIG. 10B) exhibits a state of selection of the e-mail job on the job selection screen shown in FIG. 8B, and the second image (FIG. 10A) exhibits a job list that appears as a result of selection of the e-mail job. The job list contains such security information as transmission destination data, and is, therefore, displayed on the second image.

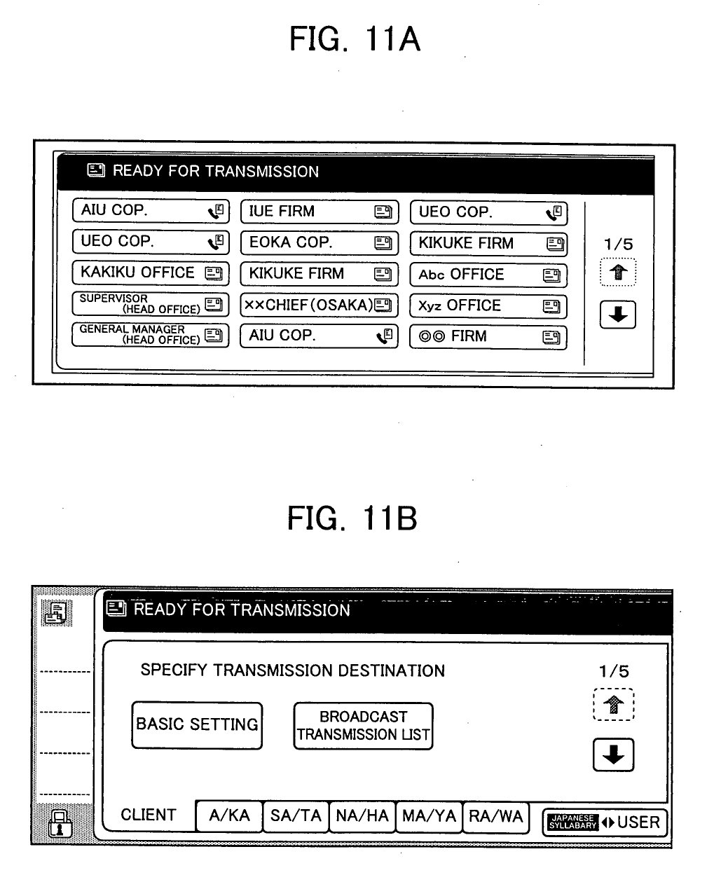

FIGS. 11A and 11B depict still other examples of displays of the first image and the second image. FIG. 11A depicts the second image that can be viewed via the reflecting portion 30, and FIG. 11B depicts the first image that can be viewed by directly looking into the display portion 20.

FIGS. 11A and 11B represent setting screens for transmitting an image taken into the MFP in a scanner mode. Here, the second image (FIG. 11A) exhibits a screen of an address book of transmission destination, and the first image (FIG. 11B) exhibits an index screen of the address book. The address book screen contains such security information concerning transmission destinations as company names, individual names, and managerial positions. The address book screen is, therefore, displayed on the second image.

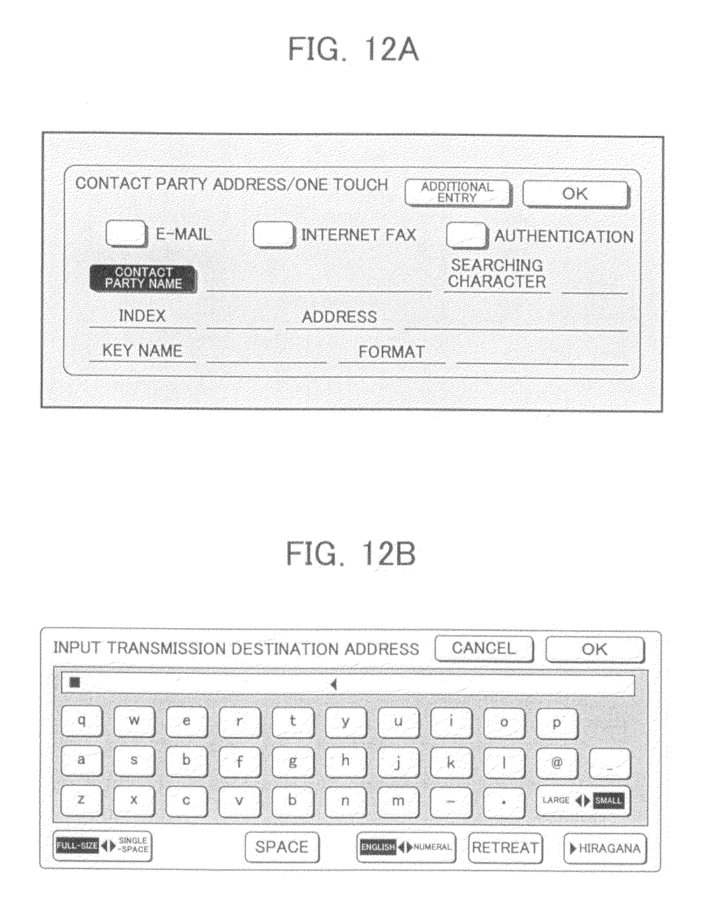

FIGS. 12A and 12B depict still other examples of displays of the first image and the second image. FIG. 12A depicts the second image that can be viewed via the reflecting portion 30, and FIG. 12B depicts the first image that can be viewed by directly looking into the display portion 20.

FIGS. 12A and 12B represent setting screens for address book information retained by the MFP. Here, the second image (FIG. 12A) exhibits a screen for address book setting, and the first image (FIG. 12B) exhibits a screen of an alphabetical key for setting input. The screen for address book setting contains such security information as names and addresses of contact parties and is, therefore, displayed on the second image.

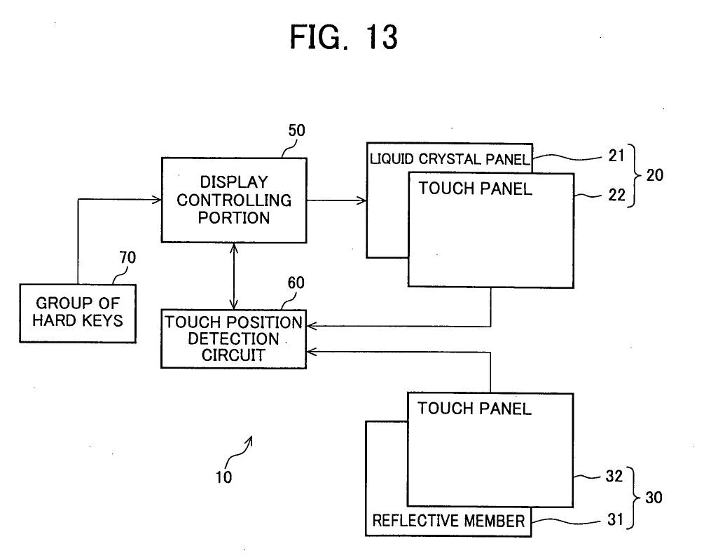

FIG. 13 is a block diagram for explaining the internal configuration of the display apparatus according to the present invention. The display apparatus 10 includes the dual view liquid crystal panel 21, the first touch panel 22 formed on the dual view liquid crystal panel 21, the reflective member 31, which is a mirror, etc., the second touch panel 32 formed on the reflective member 31, a display controlling portion 50, a touch position detection circuit 60, and the group of hard keys 70 including ten-key.

The touch position detection circuit 60 detects a change in surface charges on the first touch panel 22 to calculate coordinate values that indicate a user's touching position on the first touch panel 22, and puts the calculated coordinate values into the display controlling portion 50.

The touch position detection circuit 60 detects a change in surface charges on the second touch panel 32 to calculate coordinate values that indicate a user's touching position on the second touch panel 32, and puts the calculated coordinate values into the display controlling portion 50.

The display controlling portion 50 is a computer that controls the display operation of the dual view liquid crystal panel 21, and is composed of a CPU, a RAM, a ROM, etc. The display controlling portion 50 detects a touching position on each touch panel on the basis of input coordinate values from the touch position detection circuit 60, and changes the contents of the first image and the second image displayed on the dual view liquid crystal panel 21 and controls display areas for the first image and the second image according to the detected touching position. The display controlling portion 50 also carries out display condition setting and display control according to the operation input from the group of hard keys 70.

While the embodiment of the present invention has been described heretofore, the configuration of the display apparatus of the present invention is not limited to the above configuration wherein a single reflective member 31 is used, but the display apparatus may be configured using one or more reflective members. For example, the display apparatus may be provided with a first reflective member that reflects the second image displayed on the display portion 20, and with a second reflective member that further reflects the second image reflected on the first reflective member toward a desired visual position. In this case, the second image is reflected twice to be viewed. The second image is, therefore, displayed not in the form of a mirror image as described above but in the form of an ordinary image.

The display apparatus of the present invention can be applied not only to the above MFP, but also to various electronic apparatuses for industrial use or general use. For example, the display apparatus can be applied to such an electronic apparatuses as ATM and various vending machines.

The display apparatus of the present invention is applicable also to an electronic apparatus on which input operation is performed using input operation devices and keys other than a touch panel. For example, the display apparatus can be applied to such an appliance as refrigerator, washing machine, etc., if the appliance has a display screen. The display apparatus of the present invention enables the appliance to display information of which security must be secured without allowing another person to view the information.

The present invention offers the following effect. The present invention enables display that maintains security through a narrow limited range of a view angle of a display screen displaying security information by causing a reflective member to display the security information in the use of a dual view liquid crystal display having view angles in different directions.

According to the present invention, when a user performs operation on the display screen and another person near the user peeps into the reflective member, another person has difficulty in seeing security information displayed on the display screen because a range allowing viewing of the displayed screen via the reflective member is extremely narrow. This prevents a leak of security information displayed on the display screen.

1. A display apparatus comprising a display portion capable of simultaneously displaying a first image and a second image, the first image being viewable from a position in a first view angle and the second image being viewable from a position in a second view angle, wherein
the display apparatus has a reflective member reflecting the second image and displays predetermined specific information through the second image, the reflective member offering a third view angle that allows viewing of the second image.

2. The display apparatus as defined in claim 1, so configured that the third view angle is a view angle narrower in range than the first view angle, and that both of the first image displayed by the display apparatus and the second image reflected by the reflective member are viewable from a position in the third view angle.

3. The display apparatus as defined in claim 1, wherein
the specific information is information of security.

4. The display apparatus as defined in claim 3, wherein
the specific information is information on basic setting of the display apparatus or of an apparatus incorporating the display apparatus.

5. The display apparatus as defined in claim 3, wherein
the specific information is information of personal information.

6. The display apparatus as defined in claim 3, wherein
the specific information is information on a transmission destination of data to be transmitted.

7. The display apparatus as defined in claim 1, wherein
the reflective member is adjustable in angle relative to the display portion.

8. The display apparatus as defined in claim 1, wherein
the display portion so carries out display as to make a display area for the second image smaller than a display area for the first image.

9. An electronic apparatus having the display apparatus as defined in claim 1 and allowing given operational input to the display apparatus.
